(19) United States
(12) Patent Application Publication
(10) Pub. No.: US 2002/0090240 A1
(43) Pub. Date: Jul. 11, 2002

(54) System and method for printing a design on a selected printable media at a selected printing facility

(75) Inventor: Chris Lively, Addison, TX (US)

Correspondence Address: J. Kevin Gray, Esq., Jenkens & Gilchrist, P.C., Suite 3200, 1445 Ross Avenue, Dallas, TX, 75202-2799, US

(73) Assignee: Artfulgiving.com, Inc., Dallas, TX

(21) Appl. No.: 10/098,033

(22) Filed: Mar. 14, 2002

Related U.S. Application Data
(63) Continuation-in-part of application No. 09/538,612, filed on Mar. 29, 2000.

(51) Int. Cl. B41J 11/44

(52) U.S. Cl. 400/76

(57) ABSTRACT

A system and method is disclosed for creating, ordering and printing custom-created graphical images on a variety of printable media via a data network, such as the Internet or Intranet. The system includes a database storing references to available graphical image options (background, text, icons and overall layout), pricing information and customer information and a distributed printing system including one or more printers located at one or more printing facilities for printing printed products. The system further includes a distributed order processing system having one or more order processors associated with one or more printers at a printing facility, in which each of the order processors is capable of requesting an order that includes the references to the selected graphical image options from the database. Each order processor further includes a rendering agent that interprets the order to produce a final print image for printing on one of the associated printers at the printing facility.

This U.S. Nonprovisional Application for Patent is a continuation-in-part of U.S. Nonprovisional Application for Patent Serial No. 09/538,612, filed on Mar. 29, 2000. U.S. Nonprovisional Application for Patent Serial No. 09/538,612, is hereby incorporated by reference in its entirety herein.

### BACKGROUND OF THE PRESENT INVENTION

1. Field of the Invention

The present invention relates generally to ordering and printing custom-created designs on printable media, and specifically to facilitating the creation, ordering and printing of custom-created designs on printable media via the Internet.

2. Background and Objects of the Present Invention

A variety of software applications are currently available to provide users with the ability to create custom designs that can be printed on various types of printable media, such as plain paper, greeting cards, business cards, stationary, wallpaper, wrapping paper, blueprints and signs or banners. As an example, Photoshop or Corel Draw software in combination with a scanner can be used to create almost any type of design (background, text and picture or icon) that the user can imagine.

However, these software applications typically require the user to have significant training in using the software in order to create these designs. In addition, for some types of printable media (such as wallpaper, wrapping paper and signs or banners), the user must have access to specialized printers in order to print out the custom-created design onto the desired printable media. In some cases, this may require the services of a separate printing facility.

However, if the user created the design on a remote computer, it may be impractical or impossible to provide the design to the printing facility. In some cases, the user or printing facility employee may have to re-create the design at the printing facility site. Alternatively, the user may have to download the design to a transportable storage media, such as a diskette, and hand-carry the diskette to the printing facility site. Therefore, what is needed is a system for a user to easily create designs and print the custom-created designs on a variety of printable media at a printing facility of the customer's choosing.

### SUMMARY OF THE INVENTION

The present invention is directed to a system and method for creating, ordering and printing custom-created designs on a variety of printable media via a data network, such as the Internet or an Intranet. The system includes a database storing references to available graphical image options (background, text, icons and overall layout), pricing information and customer information and a distributed printing system including one or more printers located at one or more printing facilities for printing printed products. For example, in one embodiment, the distributed printing system includes one or more remote printers that are located at one or more printing facilities located remote from the system facility. In other embodiments, the distributed printing system includes one or more printers located at the system facility.

The system further includes a distributed order processing system having one or more order processors associated with one or more printers at a printing facility, in which each of the order processors is capable of requesting an order that includes the references to the selected graphical image options from the database. Each order processor further includes a rendering agent that interprets the order to produce a final print image for printing on one of the associated printers at the printing facility. In addition, the distributed order processing system also serves as a billing system to verify account and billing information, along with delivery information.

The system further includes a web server housing a web site accessible by users to retrieve one or more of the available graphical image options and create an order representing a custom-created design to be printed on a selected printable media, such as plain paper, greeting cards, business cards, stationary, wallpaper, gift-wrapping paper, blueprints and signs or banners. The web site can be directly accessible or indirectly accessible through a partner web site. In addition, the web site can be a hosted web site that is accessible through a local area network (LAN) from a facility connected to that LAN. In an alternative embodiment, the system includes a stand-alone application directly accessible to a user and having a connection to the database via a data network (such as an Intranet or Local Area Network).

Advantageously, using a distributed printing system allows the system and method of the present invention to make use of printing facilities remotely located from the system's own printers. For example, companies such as Hewlett Packard have set up print facilities around the United States and abroad where a large number of high-speed printers are co-located. Other examples of remote printing facilities include, but are not limited to, the printing facilities at Kinkos Copy Centers, Mail Boxes, Etc. and various universities around the world. By utilizing the distributed printing system, users of the system of the present invention can direct that products designed and created utilizing the system be sent to a convenient location for printing and pickup.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram of the main components of the on-line creating, ordering and printing system of the present invention;

FIG. 2 is a diagrammatic view of the overall system used in creating and ordering custom-created designs via the Internet, and printing the custom-created designs remotely on a selected printable media, in accordance with preferred embodiments of the present invention;

FIG. 3 is a flow chart of the overall method used in system shown in FIG. 2 of the drawings;

FIG. 4 is a diagrammatic view of a preferred system for creating the custom-designed designs to be printed on the selected printable media;

FIG. 5 is a flow chart illustrating the steps for creating the custom-designed designs to be printed on the selected printable media;

FIG. 6 is a diagrammatic view of a preferred system for ordering and printing the custom-created designs on the selected printable media;

FIG. 7 is a flow chart illustrating the steps for ordering and printing the custom-created design on the selected printable media;

FIGS. 8A-8E are diagrams of the various possible parameters included in the order submitted to the order processing system;

FIG. 9 is a block diagram of an alternative embodiment showing the up-loading of a custom-created design to the web site via the Internet to be remotely printed on a selected printable media; and

FIG. 10 is a block diagram of a distributed printing system and distributed order processing system in accordance with embodiments of the present invention.

### DETAILED DESCRIPTION OF THE EXEMPLARY EMBODIMENTS

The numerous innovative teachings of the present application will be described with particular reference to the exemplary embodiments. However, it should be understood that this class of embodiments provides only a few examples of the many advantageous uses of the innovative teachings herein. In general, statements made in the present application do not necessarily delimit any of the various claimed inventions. Moreover, some statements may apply to some inventive features but not to others.

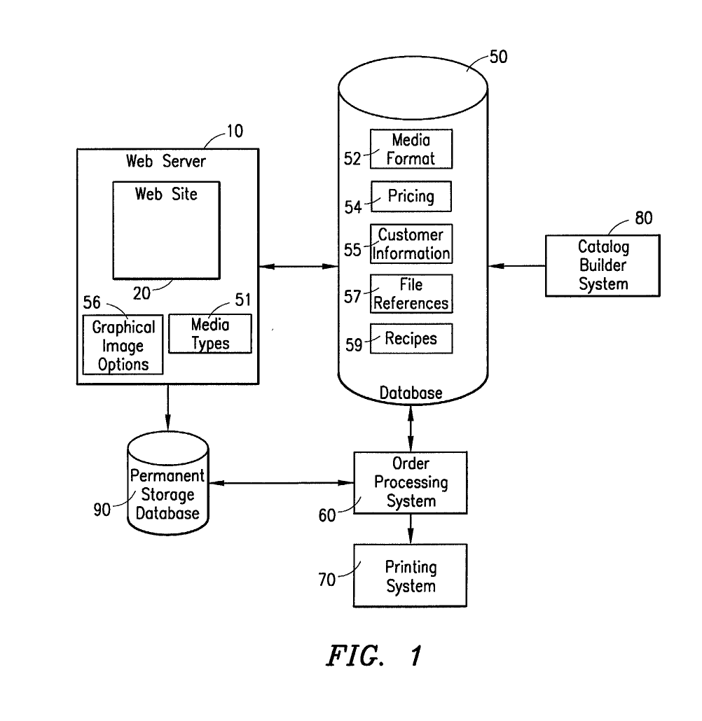

FIG. 1 is a high-level block diagram illustrating the main components of the system of the present invention for ordering and printing custom-created designs on a variety of printable media via a data network, such as the Internet or an Intranet. The system includes a web server 10, such as Microsoft's Internet Information Server, housing a web site 20 accessible by Internet users (not shown), a database 50, such as Microsoft Access or MS SQL Server 7, an order processing system 60 and a remote printing system 70 for printing printed products. It should be noted that as used herein the term “printed product” is intended to refer to any finished good created by the printing system 70.

The web server 10 stores a number of available, pre-defined graphical image options 56 and printable media types 51, while the database 50 stores references 57 to the graphical image options, media type format information 52, pricing information 54 and customer information 55. The pre-defined graphical image options 56 include background, text, icons and overall layout options for the Internet user to select from. These graphical image options 56 are preferably stored in Encapsulated PostScript (EPS) type or JPEG files, and file name references 57 to these files are stored in the database 50. It should be noted that each printable media 51 has media format information 52 associated therewith and stored in the database 50. The media format information 52 includes information pertaining to the printable media type 51 that the Internet user selects to have their custom-created design printed upon. The media type format information 52, pricing information 54 and customer information 55 are preferably stored as tables within the database 50. Together, the graphical image options 56, media types 51, media type format information 52 and pricing information 54 contain all of the information needed for the Internet user to fully describe the visual layout and price of the printed product.

It should be noted that as used herein, the term “printable media” is intended to refer to any medium which may be printed upon by the printing system 70. For example, the term “printable media” can include plain paper, greeting cards, business cards, stationary, wallpaper, gift-wrapping paper, blueprints, signs or banners. In addition, the term “printing” is intended to include any method of printing a custom-created design onto a printable media to create the final printed product.

The system also includes a catalog builder system 80 interfaced with the database 50 that allows for the creation and storage of combinations of the various graphical image options 56 on the database 50. These combinations are referred to as pre-defined recipes 59 created by administrators of the system, which can be used by Internet users in creating the custom-created design. Alternatively, the pre-defined recipes 59 can be downloaded from an available graphical image software application, such as Illustrator™. These recipes 59 include file references 57 to the selected graphical image options 56 on the web server 10. In addition, the system includes a permanent storage database 90 for storing the recipes 59 of the custom-created designs created by Internet users.

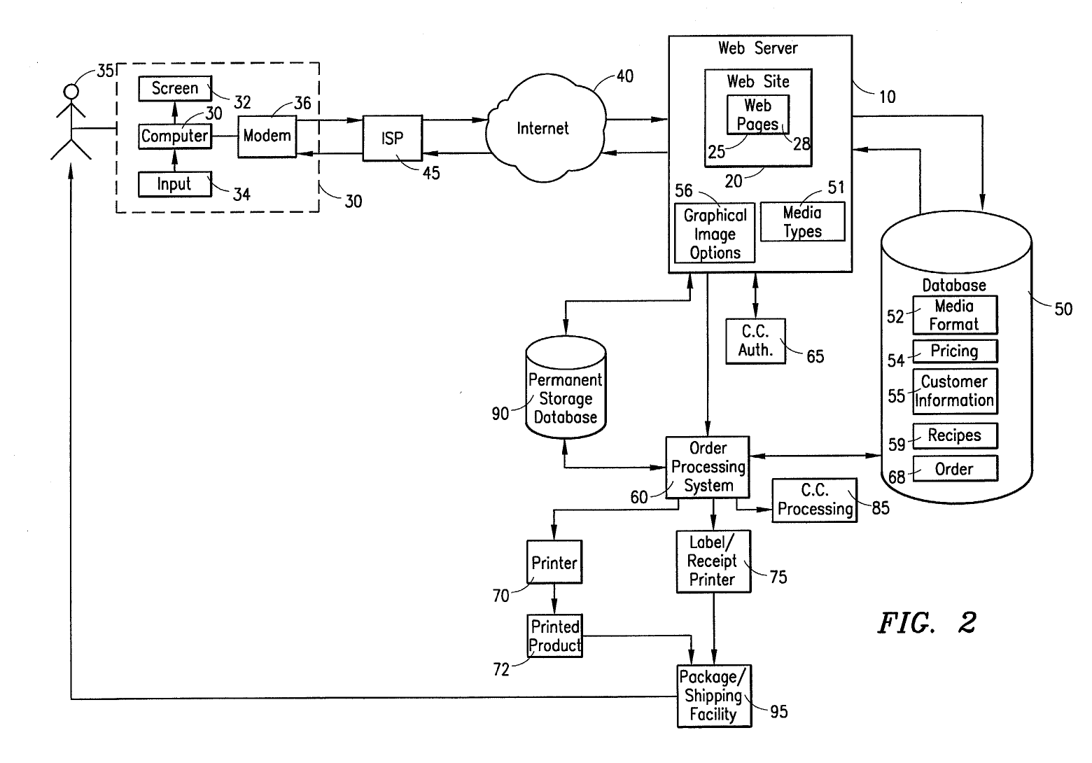

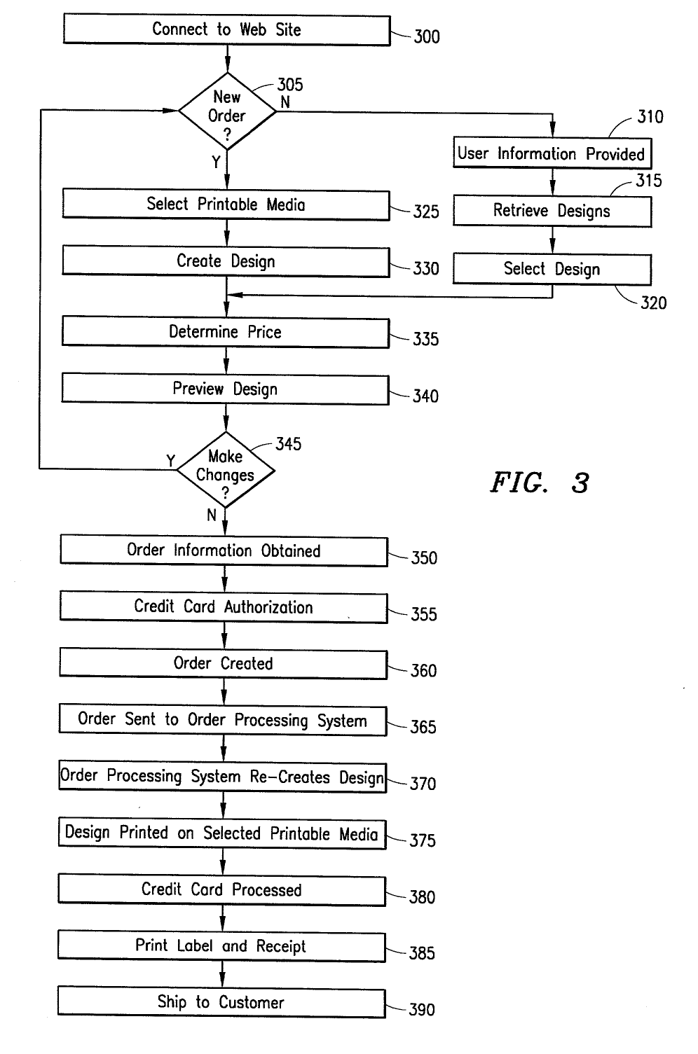

Turning now to FIG. 2 of the drawings, which will be described in connection with the steps listed in FIG. 3 of the drawings, the preferred system and method for creating, ordering and printing the printed product, shown as 72, is shown. Initially, an Internet user 35 can access the web site 20 by dialing up an Internet Service Provider (ISP) 45 or Internet browser, which provides access to the Internet 40, through a modem 36 on their computer 30, and entering the Uniform Resource Language (URL) address of the web site 20 (step 300).

Once the computer 30 has connected to the web site 20, the web site 20 will push one or more web pages 28 to the computer screen 32. Each web page 28 typically contains a number of different form elements (not shown), such as “Buttons,” “Hyper-Links,” “Text Boxes” and “List Boxes” that represent options available to the Internet user 35 that the Internet user 35 may “press” to select. For example, once the Internet user 35 has indicated that he/she wants to order a custom-created printed product 72, two form elements may appear on the screen 32, one to indicate that Internet user 35 wants to create a new order and one to indicate that the Internet user 35 wants to use an existing order. The Internet user 35 selects from the options (new order or existing order) through the use of an input mechanism 34 on their computer 30, such as a touch screen, keyboard or mouse.

If an existing order is selected (step 305), the Internet user 35 is prompted for their user information 55, such as the Internet user's name, address and other pertinent information (step 310) The web site 20 uses this user information to retrieve all of the designs (recipes 59) previously created by the Internet user 35 from the permanent storage database 90 using the customer information 55 stored on the database 50 (step 315). Once retrieved, the web site 20 pushes a web page 28 containing “Hyper-Links” associated with the previously created designs to the screen 32. These “Hyper-Links” could be reduced images of the designs or file names associated with the designs. Thereafter, the Internet user 35 selects the “Hyper-Link” associated with the desired previously created design (step 320).

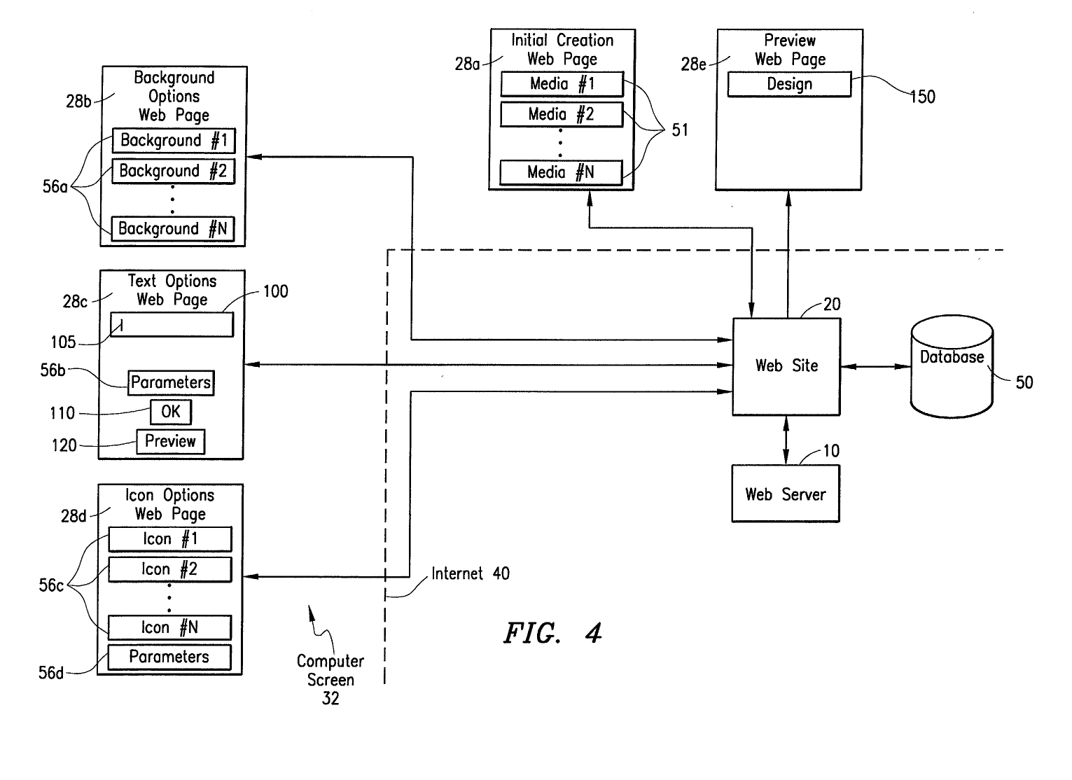

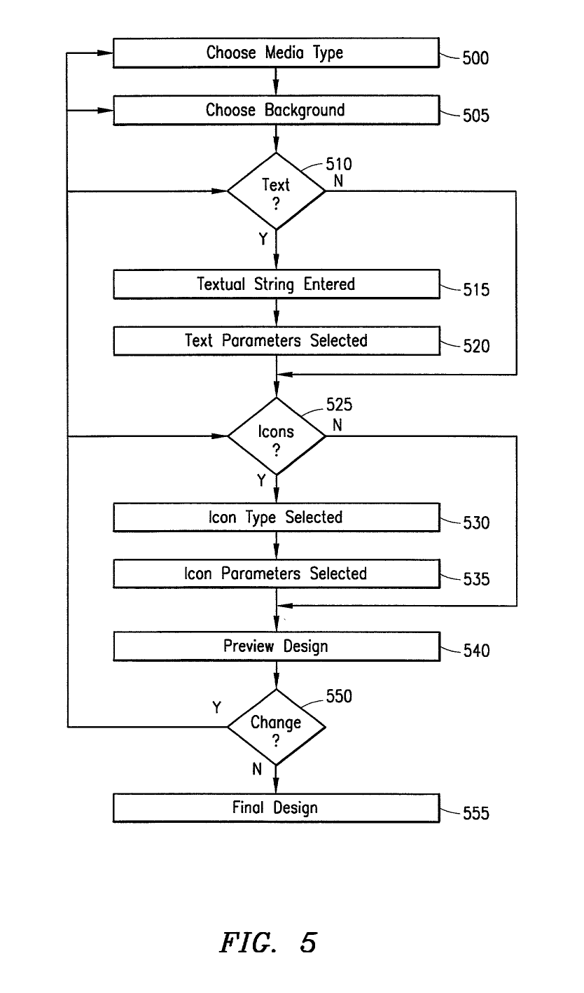

If a new order is selected (step 305), the Internet user 35 must design the custom-created design through the use of available printable media options 51 and graphical image options 56, which are stored on the web server 10, or through the use of pre-defined recipes 59 stored on the database 50. For example, each “button” or other form element on the initial creation web page 28 may represent a different printable media type 51 for the Internet user 35 to select from. Once a printable media type 51 is chosen (step 325), the Internet user 35 is prompted to select the desired graphical image options 56 (background, text, icons and overall layout of the design) through subsequent creation web pages 28 (step 330). The process of selecting the printable media and design is described more fully in the description accompanying FIGS. 4 and 5.

It should be noted that the web site 20 preferably contains one or more memories 25 for storing the web pages 28. In addition, the one or more memories 25 also contain algorithms or logic for selecting and transmitting the web pages 28 to the Internet user's computer 30, receiving selected options from the Internet user's computer 30, transmitting graphical image options 56 and printable media types 51 to the Internet user's computer 30, retrieving pricing information 54 from the database 50 and formatting the web pages 28 with the pricing information retrieved from the database 50.

Once the printable media type 51 and design (desired graphical image options 56) or the desired previously created design have been selected, the web site 20 accesses the database 50 to determine the price 54 per printed product (step 335), and pushes a web page 28 containing a preview of the design to the computer screen (step 340). This web page 28 also preferably contains an “OK” button and a “Make Changes” button. If the Internet user 35 wants to make any changes to the design (step 345), the Internet user 35 selects the “Make Changes” button, and the web site 20 pushes one or more of the creation web pages 28 back to the screen depending on which graphical image options 56 the Internet user 35 wants to change (step 305). Otherwise, the Internet user 35 selects the “OK” button.

Thereafter, the Internet user 35 is prompted for order information (step 350), such as the user information 55 (for a new order), the number of printed products, the method of payment, the billing address, the shipping address and the method of shipping. In most cases, the method of payment will be via credit card. Therefore, the method of payment information normally includes the type of credit card, the credit card number, the name on the credit card and the expiration date. Once the user enters the number of printed products desired, a web page containing the price 54 per printed product is displayed on the computer screen 32. The price is calculated by accessing pricing information 54 in the database 50. For example, the price can be calculated on a per linear foot basis or quantity basis.

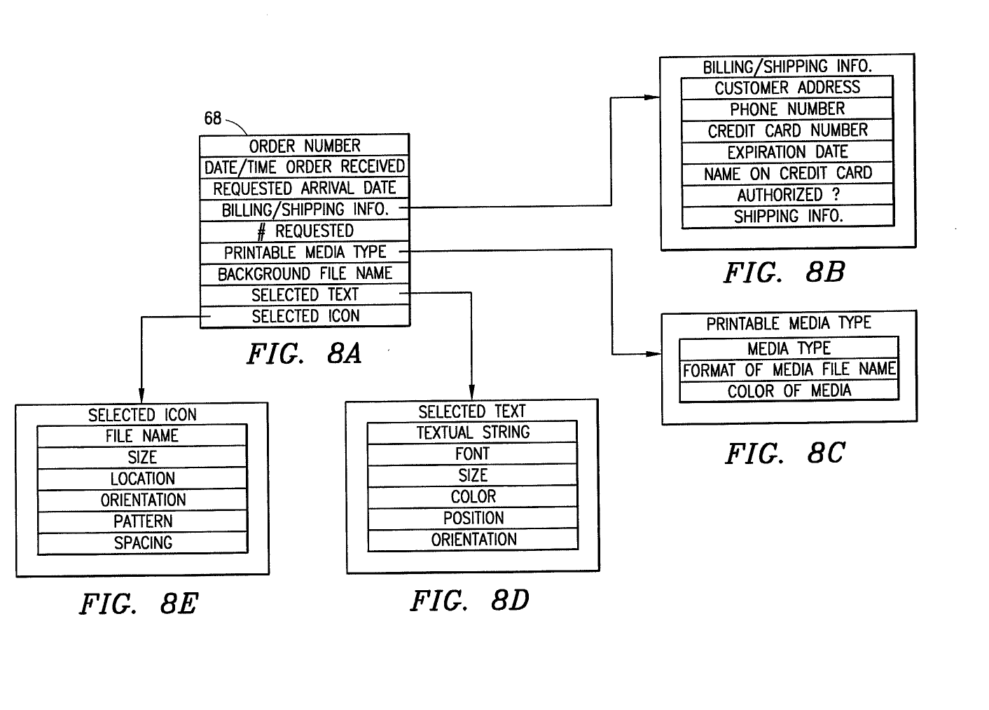

Once the order information is obtained by the web site 20, the web site 20 accesses a credit card authorization system 65 to verify the credit card information (step 355). The verification process is used to “pre-authorize” the credit card for the intended amount. However, it should be understood that the funds are not actually captured until the product is shipped. If verification is obtained, the web site 20 creates an order 68 containing the recipe 59 on how to build the custom-created design (selected printable media type 51 and graphical image options 56), along with the order information (step 360). The various parameters included in the order are discussed more fully in the description accompanying FIGS. 8A-8E.

This order 68 is sent to the database 50 for storage therein (step 365). Thereafter, the order processing system accesses the database 50 to retrieve the order 68, and uses the recipe included in the order, along with the media format information 52 for the selected media type 51 included in the database 50, to re-create the custom-created design (step 370). Once re-created, the order processing system sends the custom-created design to the printing system 70 for creation of the printed product(s) 72 (step 375). Once the printed product(s) 72 are complete, the order processing system 60 accesses a credit card processing system 85, which actually charges the credit card of the Internet user 35 (step 380). In addition, the order processing system 60 instructs at least one additional printer 75 to print a receipt and a label for the package that will include the printed product(s) 72 (step 385). Thereafter, the printed product(s) 72, receipt and label are transmitted to a packaging/shipping facility 95, which can be located in the same facility as the printing system 70, which ships the printed product(s) to the Internet user 35 (step 390).

With reference now to FIG. 4 of the drawings, which will be described in connection with the steps listed in FIG. 5 of the drawings, a diagrammatic view of a preferred system for creating the custom-designed designs to be printed on the selected printable media is shown. As discussed hereinbefore, the Internet user accesses the web site 20 through the use of the Internet user's computer, and the web site 20 pushes web pages to the Internet user's computer screen 32. Once the Internet user has indicated that he/she wants to create a design to be printed on a printable media, the web site 20 pushes an initial creation web page 28a to the screen 32.

As shown in FIG. 4, this initial creation web page 28a will typically contain a number of form elements, such as “buttons,” each indicating a different type of printable media 51. As an example, assuming the Internet user would like to order custom designed wrapping paper, the Internet user would press (using the mouse, touch screen display or keyboard) the “button” associated with wrapping paper media 51 (step 500). Once the wrapping paper media type 51 has been selected, the web site 20 transmits the graphical image options 56 stored on the web server 10 that are available for the wrapping paper media 51.

For example, referring again to the wrapping paper example, initially, the web site 20 pushes a creation web page 28b containing background options 56a to the computer screen 32. Backgrounds 56a may represent pre-printed paper (on which the Internet user may print selected text and icons), or the backgrounds 56a may be themselves printable. Each “Button” on the background creation web page 28b may contain a written description of the background 56a, such as “Stars” or “Confetti,” a visual (graphical) representation of the background 56a or both. For example, the background creation web page 28b may be composed of a plurality of web pages, in which an initial web page contains written description “Buttons” of each available backgrounds 56a and associated select and preview “Buttons,” and subsequent web pages, which can be accessed through the associated preview “Buttons,” contain visual representations of each of the available backgrounds 56a. In some embodiments, image options (not shown) can be selected from instead of background options 56a. For example, if the user selects the poster media 51, the user may be provided with various image options (e.g., pictures of people, places, animals, etc.) for the poster.

Once the Internet user has selected the background 56a for the wrapping paper (step 505), the web site 20 can push a text creation web page 28c to the computer screen 32, which inquires whether the Internet user would like to include text on the wrapping paper (step 510). If the Internet user does want to include text, the Internet user can type a textual string 105 in a box 100 provided on the web page 28c (step 515). For example, the Internet user may be purchasing the wrapping paper to wrap a birthday gift to his/her mother, and may want the wrapping paper to say “Happy Birthday Mom.” Therefore, the Internet user would enter this textual string 105 in the box 100 and select an appropriate selection “Button,” 110 such as “OK,” on the web page 28c to cause the web site 20 to include this textual string 105 on the wrapping paper.

The text web page 28c can also provide various text parameter options 56b to the Internet user (step 520). For example, the Internet user may be able to select the font, size, color, position (top, middle, bottom, right-justified, left-justified, centered) and orientation (straight, angled up or angled down) of the text using a text parameters “Button” 56b or several “Buttons” on the text web page 28c. It should be understood that the text web page 28c may also include multiple web pages to allow the Internet user a full range of choices. Once the Internet user has selected all of the textual parameters 56b, the Internet user can select a preview “Button” 120 to cause the web site 20 to display on the screen 32 a preview web page 28e, which displays the current design 150, with the background 56a and text 105 in the desired format 56b. At this point, the Internet user will be able to go back and make any changes to the text and/or background, using conventional techniques, such as a “Go Back” button, until the Internet user is satisfied with the selections.

After the Internet user has selected the background 56a and entered any text 105 and text parameters 56b, the web site 20 will push an icon creation web page 28d to the computer screen 32 to allow the Internet user to select zero or more icon types 56c (step 525). It should be noted that the user can select the icon first, instead of selecting text first, depending on the implementation of the system. Furthermore, the icons can be associated with certain “occasions,” so that an Internet user could first select an “occasion” and then select from the icons associated with that “occasion.” It should be noted that in some embodiments, there may not be any icon options 56c (e.g., when the user has selected the poster media 51 and has selected one or more images, there may not be a need for further icons).

As discussed above in connection with the background web page 28c, the icon web page 28d may include one or more web pages with icon descriptions and/or visual representations to allow the Internet user to select the desired icon type 56c (step 530). In addition, the icon web page 28d may also include one or more icon parameter “Buttons,” 56d such as size, orientation with respect to text (before text, after text, above text, below text), location(s) on page (X,Y coordinates), pattern (crisscross repeated pattern, vertical repeated pattern, horizontal repeated pattern, etc.) and spacing between repeated icons for the Internet user to choose from (step 535).

Once the Internet user has selected all of the desired graphical image options 56 (background, text, icons and overall layout of text and icons), the web site 20 push a web page 28e to the screen 32 that displays the entire custom-created design 150 (step 540). At this point, the Internet user will be able to go back and make any changes to the icons, text and/or background (step 550) until the Internet user is satisfied with the selections (step 555).

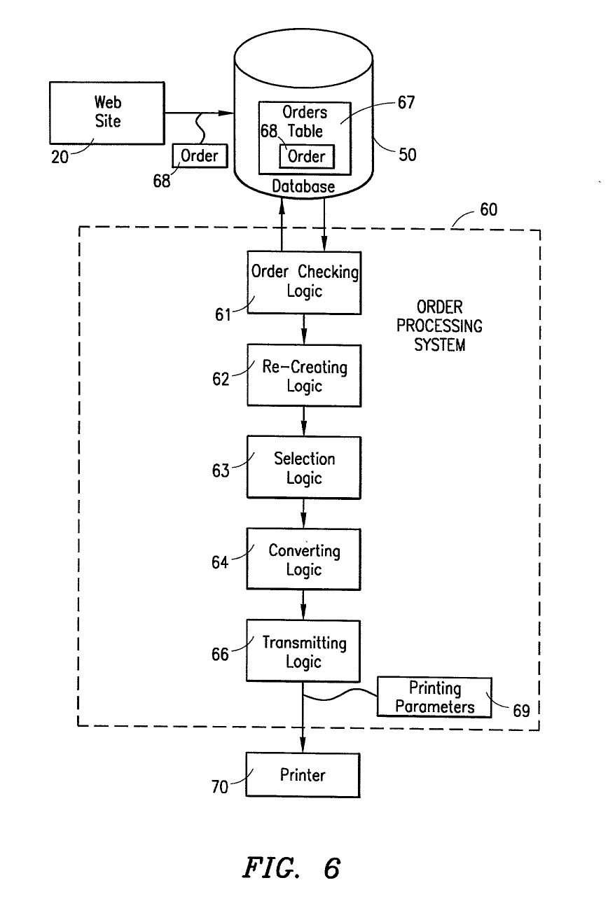

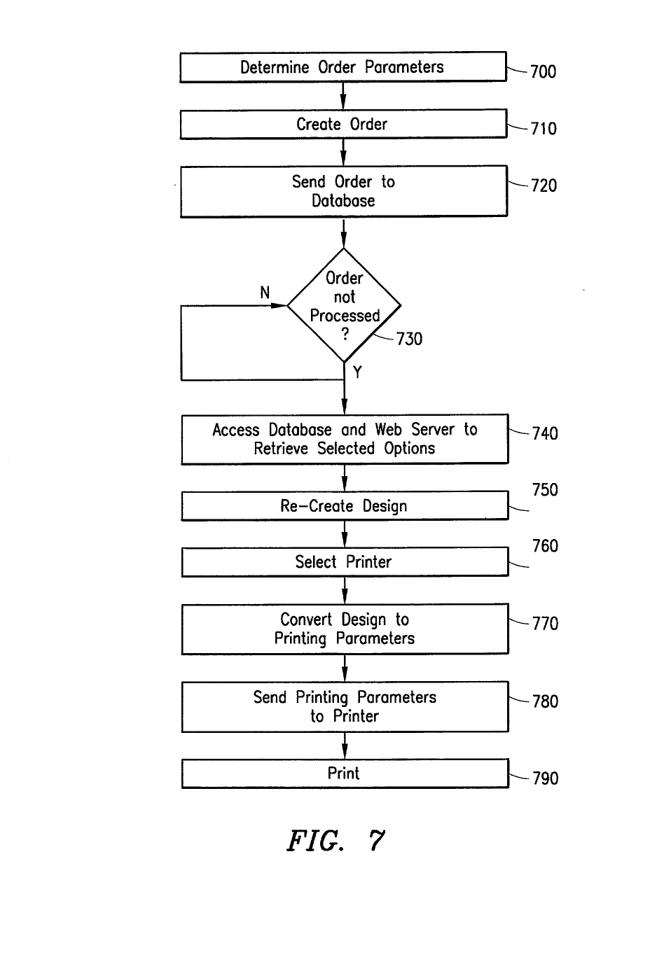

With reference now to FIG. 6 of the drawings, which will be described in connection with the steps listed in FIG. 7 of the drawings, when the Internet user has indicated acceptance of the custom-created design, the web site 20 uses the selected graphical image options and order information to determine the order parameters (step 700) and create the order 68 (step 710), which will be discussed in more detail below in connection with FIGS. 8A-8E. Thereafter, the web site 20 sends this order 68 to the database 50 for storage in an orders table 67 therein (step 720).

Periodically, order checking logic 61 within the order processing system 60 checks the orders table 67 to determine if any orders 68 have not yet been processed (step 730). If there is an order 68 in the orders table 67 that has not yet been processed, the order checking logic 61 assigns this order 68 to itself and retrieves the chosen graphical image options, media format information for the selected printable media and the pricing information associated with the custom-created design (step 740), and passes this information to re-creating logic 62 within the order processing system 60 to re-create the custom-created design (step 750).

Once the order processing system 60 has re-created the custom-created design, selection logic 63 within the order processing system 60 selects an appropriate printer 70 for the printable media type (step 760), converting logic 64 converts the custom-created design into printing parameters 69 applicable to the selected printer 70 (step 770) and transmitting logic 66 transmits the printing parameters 69 to the selected printer 70 (step 780) for printing of the custom-created design on the selected printable media (step 790).

FIGS. 8A-8E of the drawings are diagrams of the various possible parameters included in the order 68 submitted to the order processing system 60 (shown in FIG. 6). As shown in FIG. 8A, the main parameters included in the order 68 are the order number, the date and time the order was received, the requested arrival date (if any), the billing/shipping information, the number of printed products requested, the printable media type, the selected background file name, the selected text and the selected icon. It should be noted that the actual selected graphical images are not included in the order 68. Instead, the file names associated with the selected graphical images in the database are included to enable the order processing system to retrieve the actual selected graphical images from the database.

Within each of these main parameters, several sub-parameters can be included. For example, as shown in FIG. 8B, under the billing/shipping information parameter, the following sub-parameters can be included: customer (shipping) address, phone number, credit card number, credit card expiration date, name on the credit card, credit card authorization information and requested shipping method. It should be understood that more or fewer sub-parameters can be included depending on the type of information needed by the order processing system.

As another example, as shown in FIG. 8C, under the printable media type parameter, the following sub-parameters can be included: printable media type, selected color of the media (paper color) and the file name for the media format information stored within the database that is associated with the selected media type. As an example, the actual media format information could include the size of block, number of repeated blocks, size of the media and other format information, such as the width of the left, right, top and bottom margins.

The size of block and number of blocks information are normally used in larger printable media types, where the design is repeated over the surface of the printable media. For example, if the selected printable media is wrapping paper, the custom-created design must be repeated numerous times in order to print out an entire roll of wrapping paper. In many cases, the custom-created design is repeated two or three times along the width of the wrapping paper in addition to being repeated numerous times along the length of the wrapping paper. Therefore, the size of block information indicates the area (length and width) of a single instance of the custom-created design, whereas the number of repeated blocks information can be used to indicate the number of repeated blocks over the width of the media, the number of repeated blocks over the length of the media, or both.

As further examples, reference is now made to FIGS. 8D and 8E, which illustrate various sub-parameters for the selected text and selected icon parameters. For example, as shown in FIG. 8D, under the selected text parameter, the following sub-parameters can also be included: textual string, font, size, color, position and orientation. As shown in FIG. 8E, under the selected icon parameter, the following sub-parameters can be included: icon type file name, size, location, orientation, pattern and spacing. All of these sub-parameters have been discussed above in connection with FIGS. 4 and 5. It should be noted that instead of including the sub-parameters of position and orientation in the text and the icon parameters, the overall position and orientation can be included in a separate parameter, such as a layout parameter (not shown).

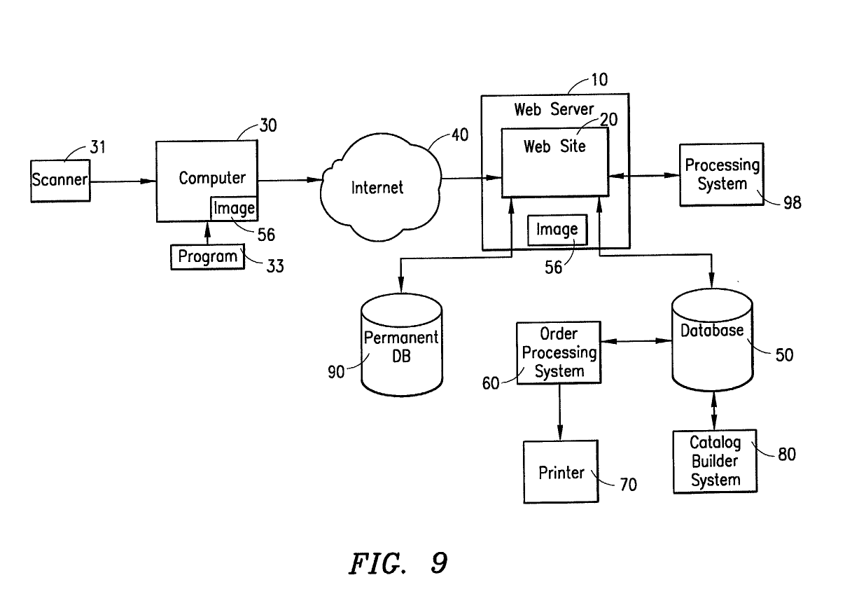

In an alternative embodiment, instead of providing background, text and/or icon options to the Internet user, the Internet user could scan in the desired graphical image (background, text and/or icon) or create original graphical images using computer software programs, and include this scanned or created graphical image in the custom-created design. For example, with reference now to FIG. 9 of the drawings, a graphical image 56, such as background, text and/or one or more icons, can be either scanned into the Internet user's computer using a color scanner 31, such as the Microtek 600Z Scan Maker, or created or up-loaded onto the computer 30 using a computer software program 33. Once the graphical image 56 is loaded onto the computer 30, when the Internet user connects the computer 30 to the web site 20 via the Internet 40, this graphical image 56 can be included in the custom-created design.

For example, when the Internet user reaches the creation web pages (background, text and/or icon web pages), the Internet user can select a “Button” for up-loading graphical images 56 from the Internet user's computer 30 to the web site 20. Once these graphical images 56 are up-loaded using conventional techniques, the web site 20 must first pass these graphical images 56 to a processing system 98, which authorizes use of the up-loaded graphical images 56. The processing system 98 scans the up-loaded graphical images 56 for content and to ensure that copyright and trademark laws are complied with to the extent possible. It should be understood that the graphical images 56 may also need to be reviewed by personnel in order to increase the likelihood that all laws are complied with.

Once approved, the up-loaded graphical images 56 can be included in the custom-created design. A temporary file name in the database 50 is assigned each approved up-loaded graphical image 56 to enable the order processing system 60 to retrieve the up-loaded graphical images 56 from the web server 10 for re-creation of the custom-created design and submission of the custom-created design to the printing system 70. The recipe 59 for the entire custom-created design, including the up-loaded graphical image 56, is stored in the permanent database 90 for later retrieval by the Internet user. In addition, the up-loaded image 56 may be reviewed by the catalog builder system 80, and if accepted, the up-loaded image 56 may be included in a pre-defined recipe 59 in the database 50 for use by other Internet users.

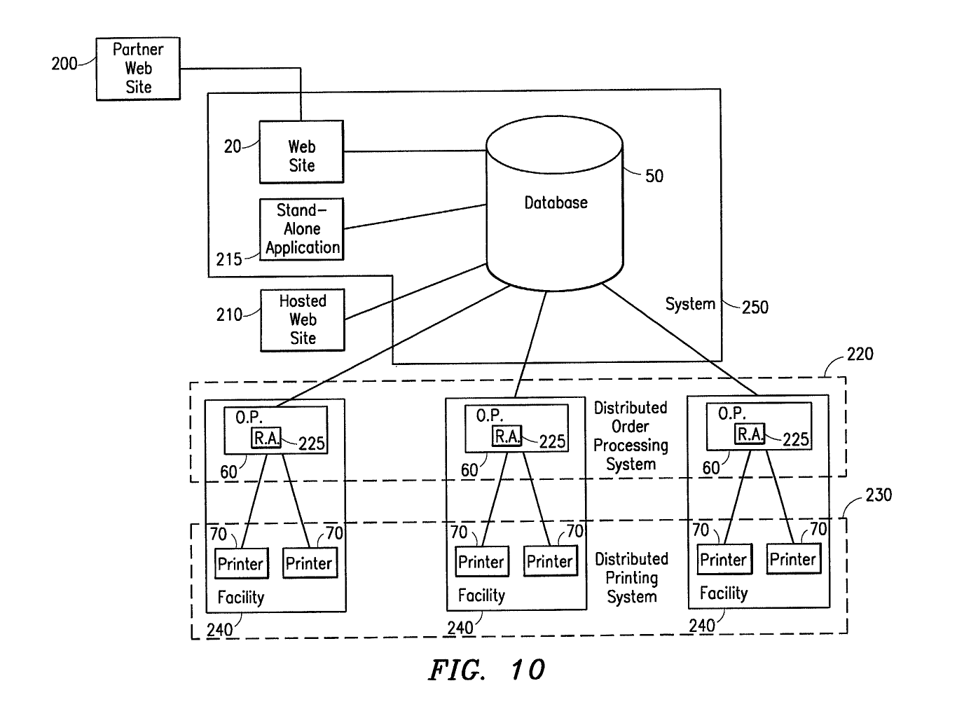

Referring now to FIG. 10, a distributed printing system 230 and distributed order processing system 220 are illustrated. The distributed printing system 230 includes one or more printers 70 located at one or more printing facilities 240 for printing printed products. The distributed order processing system 220 includes one or more order processors 60 (e.g., which corresponds in some respects to the order processing system 60 shown in FIG. 2) associated with one or more printers 70 at a particular printing facility 240, in which each of the order processors 60 is capable of receiving one or more orders from the database 50. Each order processor 60 further includes a rendering agent 225 (e.g., which may include at least the functionality of the re-creating logic 62 shown in FIG. 6) that interprets the order to produce a final print image for printing on one of the associated printers 70 at the printing facility 240.

It should be noted that the order processor 60 can be implemented on a computer connected to the printers 70 at the same physical location as the printers 70 or on a computer in a different physical location as the printers 70. It should further be understood that if multiple printers 70 are associated with a printing facility 240, the printers 70 can be located together in one physical location or in separate physical locations.

One of the printing facilities 240 can be the printing facility 240 operated by and associated with the system 250. In this case, the process is as described above in connection with FIGS. 2 and 3. However, if the printing facility 240 is remote from the system 250, the remote printing facility 240 has an order processor 60 associated therewith provided by the system that receives and processes orders utilizing the printer(s) 70 at the remote printing facility 240.

As shown in FIG. 10, a user can access the system 250 from one or more web sites 20 directly associated with the system, a stand-alone application 215, a partner web site 200 or a hosted web site 210. A partner web site 200 is a web site that is maintained by an outside company that uses the system to create designs. One example of a remote printing facility 240 is the printing facility associated with a partner web site 200.

If the user accesses the system 250 through a partner web site 200, the order processor 60 can be located at the system 250 to retrieve the chosen graphical image options, media format information for the selected printable media associated with the design from the database 50, re-create the custom-created design and convert the design into a print file containing printing parameters for the design. The order processor 60 within the system 250 can store the print file until later requested by an off-site point of sale (POS) server (not shown) associated with a third-party vendor. The order processor 60 can transmit the print file to the POS server for printing of the design on the selected printable media, as needed. In this embodiment, the order processor 60 generates a bill for the third-party vendor (not the user creating or requesting the design). The third-party vendor is responsible for billing (e.g., credit card authorization and charging) the user.

It should be noted that the user may be the partner web site 200 itself or a combination of an on-line user and the partner web site 200. In the latter case, the system provides an open and extensible framework based on standard application program interfaces (API's) that allows the partner web site 200 to transmit the graphical image options and media format types to the user and pass the selected graphical image options and media format type to the system.

A hosted web site 210 is a web site provided by the system, but separate from the system from an ownership and/or maintenance perspective. In one embodiment, the hosted web site 210 is connected to the system database 50. In other embodiments, the database 50 is only accessible by the hosted web site 210. For example, the hosted web site 210 and database 50 can be connected to and located within a local area network (LAN).

As an example, a chain of retail stores may desire to offer custom-created wrapping paper, cards, etc. to their customers on-site. To implement on-site custom-created designs and possibly on-site printing, the hosted web site 210 can be accessible to customers and/or employees of the retail stores through the LAN associated with the retail stores. The graphical image options can be the same as those offered by the system and/or custom-developed options provided only by the retail chain of stores. The selected custom-created design can be printed on the selected printable media at the store site where the order is created, at a different store site within the LAN, at the system's printing facility 240 or at a different printing facility 240. It should be noted that if the printing facility 240 is outside of the LAN, the selected graphical image options and media type must be able to be printed at the printing facility 240 (i.e., the selected options must be offered by the system).

A stand-alone application 215 is a program running on a computer (not shown), such as a personal computer or kiosk, that the user can directly access. The stand-alone application 215 can be either connected to the database 50 via a data network (e.g., Intranet or Local Area Network) or the database 50 can be included within the computer containing the stand-alone application 215. If the latter, the stand-alone application 215 within the computer has a connection to the order processor 60 via a data network for processing the order and printing the design on the selected media. It should be noted that with the stand-alone application 215, the user can create the design to be printed or the user can select from one or more pre-created designs for a particular media type. For example, the user can select a particular pre-created design to be printed on a poster or banner, and the order processor 60 uses a pre-created print file for the design to be printed on a selected printer.

Regardless of how the order is created (e.g., through the system web site 20, stand-alone application 215, partner web site 200 or hosted web site 210), the order can be processed as described above in connection with FIG. 2 or by the distributed order processing system 220 and printed using the distributed printing system 230. Either the user can select the printing facility 240 by selecting from a list of possible printing facilities 240, or alternatively, the system can maintain control over the printing facility 240 that is selected based upon predetermined scoring factors (e.g., the type of printer needed for the order, the load on the various printing facilities, the efficiency and speed of the printing facilities (domestically and internationally), the cost of the printing facilities, the shipping abilities of the printing facilities, the customer-rating of the printing facilities, etc.).

Once the printing facility 240 is selected for an order, the order processor 60 associated with the selected printing facility 240 requests the order from the database 50 by either periodically checking the database 50 to determine if there are any orders for that order processor 60 or by receiving a message from the database 50 that the order is waiting. Alternatively, the database 50 can forward the order directly to the order processor 60 without a request from the order processor 60.

In one embodiment, the order is downloaded via a data network (e.g., Internet, Intranet or LAN) from the database 50 to the order processor 60. In other embodiments, the order is transmitted to the order processor 60 as described above in connection with FIG. 2. Since the order includes the file names of the selected graphical image options, the actual files can either be downloaded to the order processor 60 from the database 50 with the order or retrieved by the order processor 60 from an accessible storage device (not shown).

Once the order and files are retrieved by the order processor 60, the rendering agent 225 interprets the order and uses the files to form the custom-created design that is the product to be printed. For example, the rendering agent 225 may use a particular RIP software (e.g., PosterJet™, PosterShop™ or PhotoPrint™) to render the custom-created design to the appropriate printer 70 for printing. After the product is printed, the order processor 60 finalizes the billing and delivery of the product to the user. For example, the order processor 60 can charge the credit card of the user, as described above, or generate a bill (paper or on-line) that is used by the printing facility 240 to charge the user upon pick-up of the product.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A system for printing a design on a selected one of a plurality of printable media, said system comprising:
a database storing an order representing the design, said order further identifying a selected one of a plurality of media types, each of said plurality of media types being associated with a different one of the plurality of printable media;
an order processing system connected to said database via a data network for receiving the order and converting the design for the selected media type into printing parameters; and
a printing system in communication with said order processing system for receiving the printing parameters and printing the design on the printable media associated with the selected media type.

2. A system for printing a design on a selected one of a plurality of printable media, said system comprising:
a database storing an order representing the design, said order further identifying a selected one of a plurality of media types, each of said plurality of media types being associated with a different one of the plurality of printable media;
an order processing system connected to said database via a data network for receiving the order and converting the design for the selected media type into printing parameters; and
a distributed printing system having at least two printing facilities separately located in communication with said order processing system, a selected one of said at least two printing facilities receiving the printing parameters and printing the design on the printable media associated with the selected media type.

3. The system of claim 1, wherein said order processing system is a distributed order processing system having at least two order processors, each being associated with a respective one of said at least two printing facilities.

4. The system of claim 3, wherein said selected printing facility has a selected one of said at least two order processors associated therewith, said selected order processor receiving the order from said database.

5. The system of claim 4, wherein the order further comprises format information associated with the selected media type, said selected order processor accessing said database to retrieve said format information associated with the selected media type to re-create the design.

6. The system of claim 4, wherein the order further comprises pricing information associated with the design, said selected order processor being further configured to generate a bill to be paid by the user for the printed design using the pricing information.

7. The system of claim 4, wherein the order further comprises pricing information associated with the design, and further comprising:
a credit card processing system connected to said order processing system for receiving credit card information from the user and processing said credit card information using the pricing information.

8. The system of claim 4, wherein said selected printing facility comprises at least one printer for printing on said selected printable media.

9. The system of claim 8, wherein said selected order processor further comprises a rendering agent for determining and rendering the printing parameters to a selected one of said at least one printer within said selected printing facility.

10. The system of claim 1, wherein said selected printable media is selected from the group consisting of: wrapping paper, signs, banners, wallpaper and blueprints.

11. The system of claim 1, wherein said order further identifies selected ones of a plurality of graphical image options selected by a user creating the design, said plurality of graphical image options including at least one of: pre-created designs, background options, image options, text options, icon options and layout options.

12. The system of claim 11, further comprising:
a web site connected to an additional data network and responsive to the user for providing one or more of the plurality of graphical image options and one or more of the plurality of media types to the user to select from, said web site being further capable of receiving the design from the user and providing the order for the design to said database.

13. The system of claim 12, further comprising:
a web server connected to the additional data network and storing said web site, said web server being configured to store said plurality of graphical image options and said plurality of media types selectable by the user.

14. The system of claim 13, further comprising:
a partner web site in communication with said web site stored on said web server, said partner web site being capable of receiving from said web site stored on said web server the one or more graphical image options and the one or more media types for the user to select from, said partner web site being further capable of providing the design to said web site stored on said web server.

15. The system of claim 12, wherein said additional data network is a local area network and said web site is a hosted web site accessible only to users within said local area network.

16. The system of claim 11, further comprising:
a stand-alone application connected to the database and responsive to the user for providing one or more of the plurality of graphical image options and one or more of the plurality of media types to the user to select from, said stand-alone application being further capable of receiving the design from the user and providing the order for the design to said database.

17. A method for printing a design on a selected one of a plurality of printable media, said method comprising the steps of:
storing an order representing the design on a database, the order identifying at least a selected one of a plurality of media types, each of said plurality of media types being associated with a different one of the plurality of printable media;
receiving the order at an order processing system connected to said database;
converting the design for the selected media type into printing parameters; and
printing at a selected one of at least two printing facilities within a distributed printing system the design on the printable media associated with the selected media type, the at least two printing facilities being separately located and in communication with said order processing system.

18. The method of claim 17, wherein said order processing system is a distributed order processing system having at least two order processors, each being associated with a respective one of said at least two printing facilities, said step of receiving further comprising the step of:
receiving the order at a selected one of said at least two order processors associated with said selected printing facility.

19. The method of claim 18, further comprising the steps of:
re-creating the design for the selected media type using the order; and
converting the design for the selected media type into printing parameters.

20. The method of claim 19, wherein the order further comprises format information associated with the selected media type, and wherein said step of re-creating further comprises the step of:
re-creating the design using said format information associated with the selected media type.

21. The method of claim 19, wherein said selected printing facility comprises at least one printer for printing on said selected printable media, and further comprising the step of:
rendering the printing parameters to a selected one of said at least one printer within said selected printing facility for printing the design on the printable media associated with the selected media type.

22. The method of claim 18, wherein the order further comprises pricing information associated with the design, and further comprising the steps of:
generating a bill to be paid by the user for the printed design based on the pricing information.

23. The method of claim 18, wherein the order further comprises pricing information associated with the design, and further comprising the steps of:
receiving credit card information from the user; and
processing said credit card information using the pricing information.

24. The method of claim 17, further comprising the steps of:
selecting, by a user via an additional data network, selected ones of a plurality of graphical image options for the design and said selected media type associated with the design using a web site connected to the additional data network, said web site providing one or more of the plurality of graphical image options and one or more of the plurality of media types to the user to select from; and
providing the order for the design from said web site to said database.

25. The method of claim 24, further comprising the step of:
storing said web site on a web server connected to the additional data network, said web server storing said plurality of graphical image options and said plurality of media types selectable by the user.

26. The method of claim 25, wherein said step of selecting further comprises the steps of:
receiving, at a partner web site in communication with said web site stored on said web server, the one or more graphical image options and the one or more media types for the user to select from; and
providing the design from said partner web site to said web site stored on said web server.

27. The method of claim 24, wherein said additional data network is a local area network and said web site is a hosted web site, and wherein said step of selecting further comprises the step of:
accessing said hosted web site only within said local area network.
